(19) United States
(12) Patent Application Publication
(10) Pub. No.: US 2007/0008428 A1
(43) Pub. Date: Jan. 11, 2007

(54) Display apparatus and control method thereof

(75) Inventor: Joo-sun Hong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/441,056

(22) Filed: May 26, 2006

(30) Foreign Application Priority Data
Jul. 7, 2005 (KR) 2005-0061387

(51) Int. Cl. H04B 1/66

(52) U.S. Cl. 348/500; 375/240.28

(57) ABSTRACT

Provided is a display apparatus including a display for displaying video thereon, further comprising a video processor for outputting to the display a digital video signal comprising digital video data (DATA), a sync signal and a clock signal (CLOCK); and a controller for controlling the video processor to insert predetermined reference data (RD) into at least one blank area of the digital video signal, and to read the reference data (RD) from the display and to control the video processor to adjust a phase of the clock signal (CLOCK) of the digital video signal based on a result of a comparison between the read reference data (RD) and the inserted reference data (RD). Thus, the present invention provides a display apparatus which adaptably compensates for poor picture quality caused by internal and/or external factors of a display apparatus and a control method thereof.

### CROSS-REFERENCE TO RELATED APPLICATIONS

This application claims the benefit under 35 U.S.C. §119(a) of Korean Patent Application No. 2005-0061387, filed on Jul. 7, 2005, in the Korean Intellectual Property Office, the entire disclosure of which is hereby incorporated by reference.

### BACKGROUND OF THE INVENTION

1. Field of the Invention

The present invention relates to a display apparatus and a control method thereof. More particularly, the present invention relates to a display apparatus, which adaptably compensates for poor picture quality caused by internal and/or external factors of a display apparatus and a control method thereof.

2. Description of the Related Art

A digital display apparatus, such as a digital TV or a digital monitor, uses a clock signal to transmit a digital video signal internally that comprises both a digital video data and a synchronization (sync) signal. The clock signal is used to synchronize the digital video data with the sync signal.

The clock signal is set up during the design or initialization during the manufacturing of the display apparatus and a phase thereof may be influenced by a physical layout of the display apparatus' components. For example, consider a video processor which converts an inputted video signal into a digital video signal and then outputs the digital video signal. The converted digital video signal comprises digital video data, a sync signal and a clock signal. If the outputted clock signal has a wrong phase, a display such as a liquid crystal display (LCD), may generate errors in reading the digital video data. The errors may cause blinking or spot noise on the displayed video.

Even if the phase of the clock signal is precisely set, operation of the components disposed in the display apparatus may be affected by operating conditions, such as an external temperature. When the display apparatus is affected by operating conditions, the phase of the clock signal may be shifted, resulting in noise.

Accordingly, there is a need for an improved display apparatus that is able to adjust the phase of a clock signal so as to avoid noise being created.

### SUMMARY OF THE INVENTION

An aspect of the exemplary embodiments of the present invention is to address at least the above problems and/or disadvantages and to provide at least the advantages described below. Accordingly, an aspect of the exemplary embodiments of the present invention is to provide a display apparatus which adaptably adjusts a phase of a clock signal to compensate for poor picture quality caused by internal and/or external factors of a display apparatus and a control method thereof.

Additional aspects and/or advantages of the exemplary embodiments of the present invention will be set forth in part in the description which follows and, in part, will be obvious from the description, or may be learned by practice of the exemplary embodiments of the present invention.

The foregoing and/or other aspects of the exemplary embodiments of the present invention are also achieved by providing a display apparatus comprising a display for displaying video thereon, further comprising a video processor for outputting to the display a digital video signal comprising digital video data (DATA), a sync signal and a clock signal (CLOCK); and a controller for controlling the video processor to insert predetermined reference data (RD) into at least one section of a blank period (BP) of the digital video signal, and for reading the reference data (RD) from the display and for controlling the video processor to adjust a phase of the clock signal (CLOCK) of the digital video signal based on a result of a comparison between the read reference data (RD) and the inserted reference data (RD).

The foregoing and/or other aspects of the exemplary embodiments of the present invention are also achieved by providing a display apparatus comprising a display for displaying video thereon, further comprising a video processor for outputting a digital video signal comprising digital video data (DATA), a sync signal and a clock signal (CLOCK); a display condition converter for converting the digital video signal output from the video processor to change display characteristics of the video displayed on the display; and a controller for controlling the video processor to insert predetermined reference data (RD) into at least one section of a blank period (BP)of the digital video signal, and for reading the reference data (RD) from the display characteristics converter and for controlling the video processor to adjust a phase of the clock signal (CLOCK) of the digital video signal based on a result of a comparison between the read reference data (RD) and the inserted reference data (RD).

According to an aspect of the exemplary embodiments of the present invention, the video processor comprises a clock signal generator for generating the clock signal (CLOCK), a sync signal generator for generating the sync signal and a video data output for outputting the digital video data (DATA), and the controller for controlling the video data output to insert the reference data (RD) into a first line after a horizontal sync signal (H-Sync) in the blank period based on the sync signal output from the sync signal generator.

According to an aspect of the exemplary embodiments of the present invention, the digital video data (DATA) output from the video data output comprises digital brightness data (Y-data) and digital color difference data, and the controller controls the video data output to insert the reference data (RD) into at least one of the digital brightness data (Y-data) and the digital color difference data.

According to an aspect of the exemplary embodiments of the present invention, the controller controls the clock signal generator to adjust a phase of the clock signal (CLOCK) such that the amount of phase adjustment is less than one period of the clock signal (CLOCK).

According to an aspect of the exemplary embodiments of the present invention, the clock signal generator sets a predetermined number of starting points in one period of the clock signal (CLOCK), and outputs the clock signal (CLOCK) according to the control of the controller by designating one of the starting points as a starting point of the clock signal (CLOCK).

According to an aspect of the exemplary embodiments of the present invention, the controller controls the clock signal generator to sequentially select the starting point of the clock signal until the read reference data (RD) is identical to the inserted reference data (RD).

The foregoing and/or other aspects of the exemplary embodiments of the present invention are also achieved by providing a method of controlling a display apparatus having a display to display video thereon, comprising inserting predetermined reference data (RD) into at least one section of a blank period (BP) of a digital video signal to be outputted to the display, the digital video signal comprising digital video data (DATA), a sync signal and a clock signal (CLOCK); reading the reference data (RD) from the display; comparing the read reference data (RD) and the inserted reference data (RD); and adjusting a phase of the clock signal (CLOCK) of the digital video signal based on a result of the comparison.

The foregoing and/or other aspects of the exemplary embodiments of the present invention are also achieved by providing a method of controlling a display apparatus having a display for displaying video thereon, a video processor for outputting a digital video signal comprising digital video data (DATA), a sync signal and a clock signal (CLOCK); and a display characteristics converter for converting the digital video signal output from the video processor to change display characteristics of the video displayed on the display, comprising inserting predetermined reference data (RD) into at least one section of a blank period (BP) of a digital video signal to be outputted; reading the reference data (RD) from the display condition converter; comparing the read reference data (RD) and the inserted reference data (RD); and adjusting a phase of the clock signal (CLOCK) of the digital video signal based on a result of the comparison.

According to an aspect of the exemplary embodiments of the present invention, the inserting the reference data (RD) comprises inserting the reference data (RD) into a first line after a horizontal sync signal (H-Sync) in the blank period based on the sync signal.

According to an aspect of the exemplary embodiments of the present invention, the digital video data (DATA) comprises digital brightness data (Y-data) and digital color difference data, and the reference data (RD) is inserted into at least one of the digital brightness data (Y-data) and the digital color difference data.

According to an aspect of the exemplary embodiments of the present invention, the changing the phase of the clock signal (CLOCK) comprises changing the phase of the clock signal (CLOCK) such that the amount of phase adjustment is less than one period of the clock signal (CLOCK).

According to an aspect of the exemplary embodiments of the present invention, the adjusting the phase of the clock signal (CLOCK) comprises setting a predetermined number of starting points in one period of the clock signal (CLOCK), and adjusting the phase of the clock signal (CLOCK) by designating one of the starting points as a starting point of the clock signal (CLOCK).

Other objects, advantages, and salient features of the exemplary embodiments of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a control block diagram of a display apparatus according to a first embodiment of the present invention;

FIG. 2 is a control block diagram to illustrate an example of a video processor of the display apparatus in FIG. 1;

FIG. 3 illustrates relations between a horizontal sync signal, a vertical sync signal and digital video data which are output from the video processor in FIG. 2;

FIG. 4 illustrates relations between reference data and a clock signal according to the first embodiment of the present invention;

FIG. 5 is a control flowchart of the display apparatus according to the first embodiment of the present invention; and

FIG. 6 is a control block diagram of a display apparatus according to a second embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

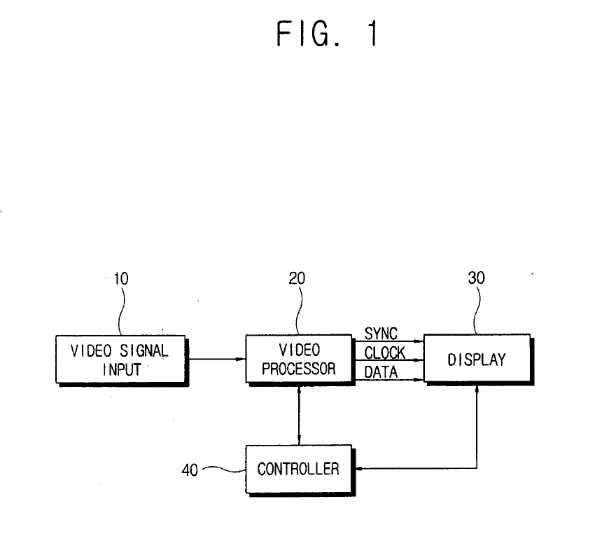

As shown in FIG. 1, a display apparatus according to a first embodiment of the present invention comprises a video signal input 10, a video processor 20, a display 30 and a controller 40.

The display 30 receives and displays thereon a digital video signal which is output from the video processor 20. The display 30 according to the first embodiment of the present invention may comprise a display module, such as a liquid crystal display (LCD), a plasma display panel (PDP), or any other type of display, which displays video thereon in accordance with the digital video signal output from the video processor 20.

The video signal input 10 may receive various types of video signals. For example, the video signal input 10 may comprise an antenna terminal to receive a terrestrial or satellite broadcast signal; a cable terminal to receive a cable broadcast signal; a composite terminal to receive a composite signal; an S-video terminal to receive an S-video signal; a component terminal to receive a component signal; an High Performance Serial Bus (IEEE 1394) input terminal to receive a IEEE 1394 signal; an High-Definition Multimedia Interface (HDMI) to receive an HDMI signal; a PC input terminal such as a D-Sub terminal or a digital video interface (DVI) to receive a PC or video signal; or any other type of input that receives video and/or image content.

The video processor 20 outputs the video signal input through the video signal input 10 as a digital video signal displayable by the display 30. Here, the digital video signal output through the video processor 20 may comprise digital video data (DATA), a sync signal (SYNC) and a clock signal (CLOCK). The sync signal (SYNC) comprises a horizontal sync signal (H-Sync) and a vertical sync signal (V-Sync). The digital video data (DATA) is synchronized by the clock signal (CLOCK) together with the horizontal sync signal (H-Sync) and the vertical sync signal (V-Sync) to be output to the display 30.

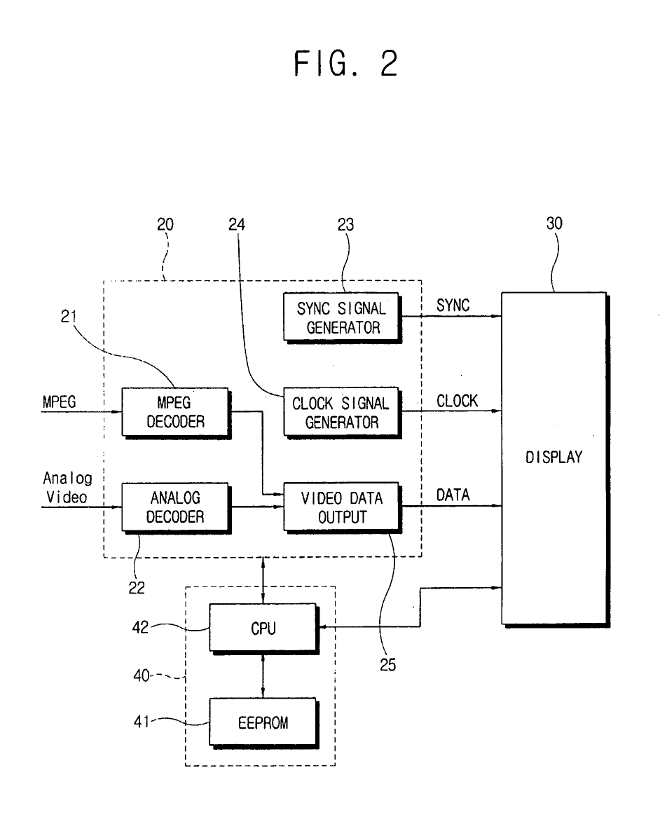

FIG. 2 is an example of the video processor 20 according to the first embodiment of the present invention. As shown therein, the video processor 20 may comprise an Moving Picture Experts Group (MPEG) decoder 21 to decode a MPEG signal input through the video signal input 10; an analog decoder 22 to convert an analog video signal input through the video signal input 10 into a digital format; and a video data output 25, such as a scaler, to convert the video signal in the digital format from the MPEG decoder 21 and/or the analog decoder 22 into the digital video data (DATA) to be outputted. The video processor 20 may comprise a sync signal generator 23 to output the horizontal sync signal (H-Sync) and the vertical sync signal (V-Sync); and a clock signal generator 24 to generate the clock signal (CLOCK).

The digital video data (DATA) output from the video data output 25 may comprise digital brightness data (Y-data) and digital color difference data (blue-data minus Y-data and red-data minus Y-data). For example, the digital brightness data (Y-data) and the digital color difference data (blue-data minus Y-data and red-data minus Y-data) may be output to the display 30 in either a 12-bit or 24-bit digital format. Further, the sync signal (SYNC) comprises the horizontal sync signal (H-Sync) and the vertical sync signal (V-Sync).

The controller 40 controls the video processor 20 to adjust display characteristics of the video being displayed on the display 30. As shown in FIG. 2, the controller 40, according to the first embodiment of the present invention, may comprise an EEPROM 41 storing a control routine that controls the video processor 20; and a CPU 42 that operates in accordance with the control routine stored in the EEPROM 41.

Meanwhile, the controller 40, according to the first embodiment of the present invention, may control the video processor 20 to insert predetermined reference data (RD) into at least one section of a blank period (BP) of the digital video signal before being outputted.

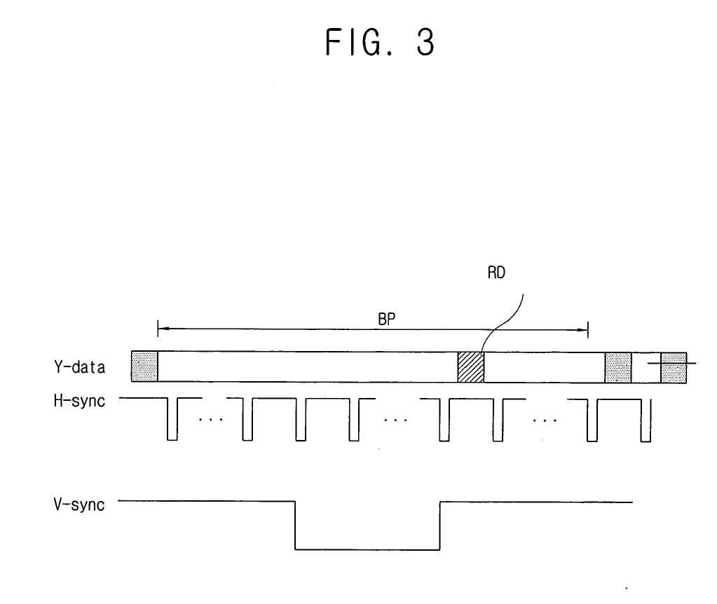

Referring to FIGS. 2 and 3, the controller 40 may control the video data output 25 of the video processor 20 to insert the reference data (RD) into the blank period (BP) of the digital video signal. For example, inserting the reference data (RD) into a first line after the horizontal sync signal (H-Sync). In the example, the controller 40 controls the video data output 25 to insert the reference data (RD) into the first line after the horizontal sync signal. (H-Sync) based on the horizontal sync signal (H-Sync) and the vertical sync signal (V-Sync) output from the sync signal generator 23.

The video data output 25 may insert the reference data (RD) into the digital brightness data (Y-data) and/or the digital color difference data of the digital video data (DATA) before being outputted.

The controller 40 reads the reference data (RD) from the display 30 after the digital video data (DATA) inserted with the reference data (RD) is outputted from the video data output 25. The controller 40 compares the read reference data (RD) and the inserted reference data (RD), and controls the clock signal generator 24 to adjust the phase of the clock signal (CLOCK) output from the video processor 20 based on a result of the comparison. For example, if the read reference data (RD) is identical to the inserted reference data (RD) than the digital video data (DATA) is synchronized with the clock signal (CLOCK) precisely.

Meanwhile, if the reference data (RD) inserted from the video data output 25 is not synchronized with the clock signal (CLOCK) precisely, the read reference data (RD) is different than the inserted reference data (RD).

The reference data (RD) output from the video data output 25 may be temporarily stored in a frame memory or a buffer based on the horizontal sync signal (H-Sync), the vertical sync signal (V-Sync) and the clock signal (CLOCK). The controller 40 reads the reference data (RD) from the corresponding frame memory or the buffer. The controller 40 and the frame memory or buffer may be connected with each other through an 12C communication line or a universal asynchronous receiver transmitter (UART) communication line.

With the foregoing method, the controller 40 adjusts the phase of the clock signal (CLOCK) and controls the digital video data (DATA) to be synchronized by the clock signal (CLOCK) if the read reference data (RD) is different from the inserted reference data (RD).

The controller 40 controls the clock signal generator 24, according to an exemplary embodiments of the present invention, to divide one period of the clock signal (CLOCK) into a predetermined number of starting points, and to adjust the phase of the clock signal (CLOCK) by designating one of the starting points as a starting point of the clock signal (CLOCK).

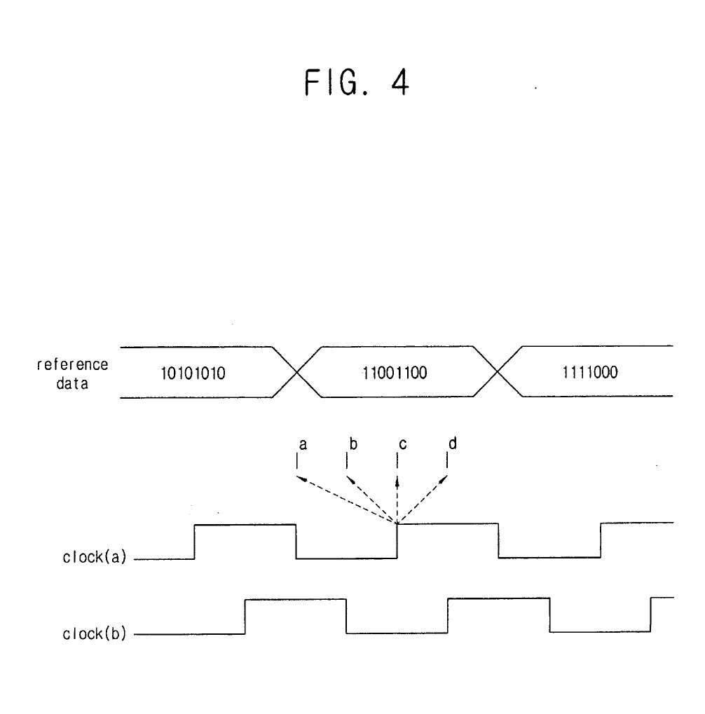

As shown in FIG. 4, the clock signal generator 24 sets four starting points in one period of the clock signal (CLOCK), and generates a clock signal (CLOCK) having “a” as the starting point. Of course any other number of starting point may be alternatively used. The video data output 25 outputs the digital video data (DATA) inserted with the reference data (RD) and synchronized by the corresponding clock signal (CLOCK).

If the inserted reference data (RD) is different than the reference data (RD) read from the display 30, the controller 40 controls the clock signal generator 24 to generate a clock signal (CLOCK) having “b” as the starting point, thereby changing the phase of the clock signal (CLOCK).

Then, the controller 40 again compares the inserted reference data (RD) and the read reference data (RD), and controls the clock signal generator 24 to sequentially output a clock signal (CLOCK) having “c” and then “d” as the starting point if the inserted reference data (RD) is different from the read reference data (RD).

With the foregoing method, the phase of the clock signal (CLOCK) output from the clock signal generator 24 is finalized with the starting point of the clock signal (CLOCK) in which the inserted reference data (RD) is identical to the read reference data (RD), among the start points “a”, “b”, “c” and “d”. Accordingly, even if the digital video data (DATA) output from the video processor 20 is not initially synchronized by the clock signal (CLOCK) due to internal or external factors of the display apparatus, the controller 40 compares the inserted reference data (RD) and the read reference data (RD) to change a sync of the clock signal (CLOCK), thereby compensating for poor picture quality caused by internal and external factors of the display apparatus.

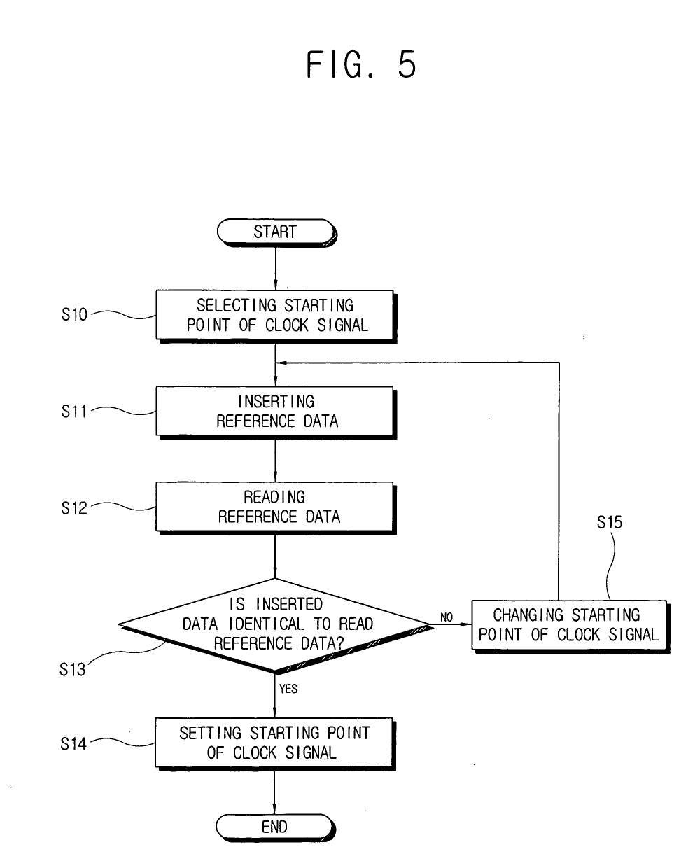

Hereinafter, a process of controlling the display apparatus according to the first embodiment of the present invention will be described with reference to FIG. 5.

As shown in FIG. 5, the clock signal generator 24 selects one of the four starting points, starting point “a” for example, at operation S10 and outputs the clock signal (CLOCK) having its phase consistent with starting point “a”. At this time, the video data output 25 inserts the reference data (RD) in the blank period (BP) of the digital video signal being outputted at operation S11.

Then, the controller 40 reads the reference data (RD) from the display 30 at operation S12. The controller 40 determines whether the read reference data (RD) is identical to the inserted reference data (RD) at operation S13.

If the read reference data (RD) is identical to the inserted reference data (RD), the controller 40 sets the current starting point “a” as the starting point of the clock signal (CLOCK) at operation S14.

Conversely, if the read reference data (RD) is not identical to the inserted reference data (RD), the controller 40 controls the clock signal generator 24 to generate the clock signal (CLOCK) having the phase of the starting point “b” at operation S15.

The controller 40 then again performs operations S11 and S12, and determines whether the read reference data (RD) is identical to the inserted reference data (RD) at operation S13, while the clock signal (CLOCK) having the phase of the starting point “b” is output.

If the read reference data (RD) is identical to the inserted reference data (RD), the controller 40 sets the current starting point “b” as the starting point of the clock signal (CLOCK) at operation S14. If the read reference data (RD) is not identical to the inserted reference data (RD), the controller 40 repeats the foregoing process for the starting points “c” and “d” to detect the starting point in which the read reference data (RD) is identical to the inserted reference data (RD).

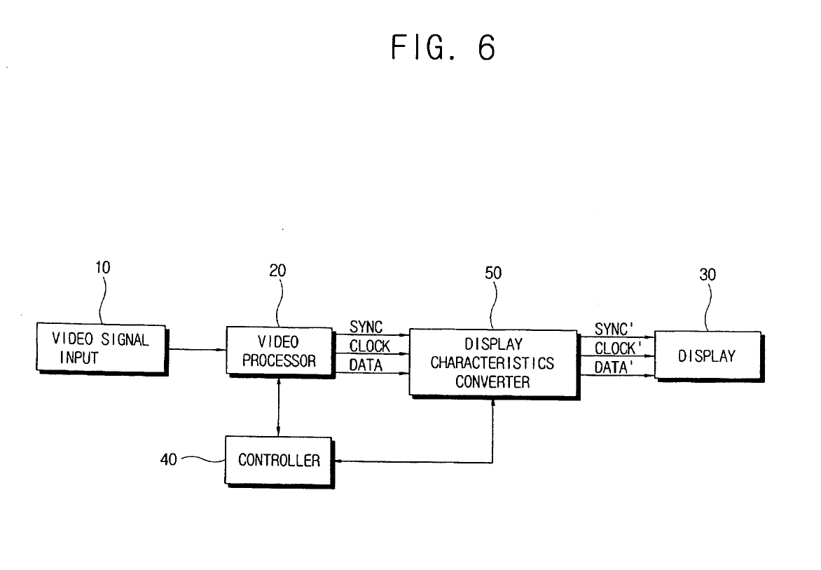

Hereinafter, a display apparatus according to a second embodiment of the present invention will be described with reference to FIG. 6.

The display apparatus according to the second embodiment of the present invention comprises a video signal input 10, a video processor 20, a display 30 and a controller 40. The display apparatus may further comprise a display characteristics converter 50 to convert a digital video signal which is output from the video processor 20 to change display characteristics of video being displayed on the display 30.

Here, the controller 40 may read reference data (RD) which is inserted into the digital video data (DATA) output from the video processor 20. Thus, the controller 40 performs the same operations as in the first embodiment of the present invention.

The digital video data (DATA) output from a video data output 25 may be temporarily stored in a frame memory or a buffer based on a horizontal sync signal (H-Sync), a vertical sync signal (V-Sync) and a clock signal (CLOCK). The controller 40 reads the reference data (RD) from the corresponding frame memory or buffer. The controller 40 and the frame memory or buffer may be connected with each other through an 12C communication line or a universal asynchronous receiver transmitter (UART) communication line.

While the invention has been shown and described with reference to certain embodiments thereof, it will be understood by those skilled in the art that various changes in form and details may be made therein without departing from the spirit and scope of the invention as defined by the appended claims.

What is claimed is:

1. A display apparatus comprising a display for displaying video thereon, further comprising:
a video processor for outputting to the display a digital video signal comprising digital video data (DATA), a sync signal and a clock signal (CLOCK); and
a controller for controlling the video processor to insert predetermined reference data (RD) into at least one section of a blank period (BP) of the digital video signal, and for reading the reference data (RD) from the display and for controlling the video processor to adjust a phase of the clock signal (CLOCK) of the digital video signal based on a result of a comparison between the read reference data (RD) and the inserted reference data (RD).

2. A display apparatus comprising a display for displaying video thereon, further comprising:
a video processor for outputting a digital video signal comprising digital video data (DATA), a sync signal and a clock signal (CLOCK);
a display characteristics converter for converting the digital video signal output from the video processor to change display characteristics of the video displayed on the display; and
a controller for controlling the video processor to insert predetermined reference data (RD) into at least one section of a blank period (BP) of the digital video signal, and for reading the reference data (RD) from the display characteristics converter and for controlling the video processor to adjust a phase of the clock signal (CLOCK) of the digital video signal based on a result of a comparison between the read reference data (RD) and the inserted reference data (RD).

3. The display apparatus according to claim 2, wherein the video processor comprises a clock signal generator for generating the clock signal (CLOCK), a sync signal generator for generating the sync signal and a video data output for outputting the digital video data (DATA), and the controller for controlling the video data output to insert the reference data (RD) into a first line after a horizontal sync signal (H-Sync) in the blank period based on the sync signal output from the sync signal generator.

4. The display apparatus according to claim 3, wherein the digital video data (DATA) output from the video data output comprises digital brightness data (Y-data) and digital color difference data, and the controller controls the video data output to insert the reference data (RD) into at least one of the digital brightness data (Y-data) and the digital color difference data.

5. The display apparatus according to claim 4, wherein the controller controls the clock signal generator to adjust a phase of the clock signal (CLOCK) such that the amount of phase adjustment is less than one period of the clock signal (CLOCK).

6. The display apparatus according to claim 5, wherein the clock signal generator sets a predetermined number of starting points in one period of the clock signal (CLOCK), and outputs the clock signal (CLOCK) according to the control of the controller by designating one of the starting points as a starting point of the clock signal (CLOCK).

7. The display apparatus according to claim 6, wherein the controller controls the clock signal generator to sequentially select the starting point of the clock signal until the read reference data (RD) is substantially identical to the inserted reference data (RD).

8. The display apparatus according to claim 1, wherein the video processor comprises a clock signal generator for generating the clock signal (CLOCK), a sync signal generator for generating the sync signal and a video data output for outputting the digital video data (DATA), and the controller for controlling the video data output to insert the reference data (RD) into a first line after a horizontal sync signal (H-Sync) in the blank areas based on the sync signal output from the sync signal generator.

9. The display apparatus according to claim 8, wherein the digital video data (DATA) output from the video data output comprises digital brightness data (Y-data) and digital color difference data, and the controller controls the video data output to insert the reference data (RD) into at least one of the digital brightness data (Y-data) and the digital color difference data.

10. The display apparatus according to claim 9, wherein the controller controls the clock signal generator to adjust a phase of the clock signal (CLOCK) such that the amount of phase adjustment is less than one period of the clock signal (CLOCK).

11. The display apparatus according to claim 10, wherein the clock signal generator sets a predetermined number of starting points in one period of the clock signal (CLOCK), and outputs the clock signal (CLOCK) according to the control of the controller by designating one of the starting points as a starting point of the clock signal (CLOCK).

12. The display apparatus according to claim 11, wherein the controller controls the clock signal generator to sequentially select the starting point of the clock signal until the read reference data (RD) is substantially identical to the inserted reference data (RD).

13. A method of controlling a display apparatus having a display for displaying video thereon, comprising:
inserting predetermined reference data (RD) into at least one section of a blank period (BP) of a digital video signal to be outputted to the display, the digital video signal comprising digital video data (DATA), a sync signal and a clock signal (CLOCK);
reading the reference data (RD) from the display;
comparing the read reference data (RD) and the inserted reference data (RD); and
adjusting a phase of the clock signal (CLOCK) of the digital video signal based on a result of the comparison.

14. A method of controlling a display apparatus having a display for displaying video thereon; a video processor for outputting a digital video signal comprising digital video data (DATA), a sync signal and a clock signal (CLOCK); and a display characteristics converter for converting the digital video signal output from the video processor to change display characteristics of the video displayed on the display, comprising:
inserting predetermined reference data (RD) into at least one section of a blank period (BP) of a digital video signal to be outputted;
reading the reference data (RD) from the display condition converter;
comparing the read reference data (RD) and the inserted reference data (RD); and
adjusting a phase of the clock signal (CLOCK) of the digital video signal based on a result of the comparison.

15. The method according to claim 14, wherein the inserting the reference data (RD) comprises inserting the reference data (RD) into a first line after a horizontal sync signal (H-Sync) in the blank period based on the sync signal.

16. The method according to claim 15, wherein the digital video data (DATA) comprises digital brightness data (Y-data) and digital color difference data, and the reference data (RD) is inserted into at least one of the digital brightness data (Y-data) and the digital color difference data.

17. The method according to claim 16, wherein the changing the phase of the clock signal (CLOCK) comprises changing the phase of the clock signal (CLOCK) such that the amount of phase adjustment is less than one period of the clock signal (CLOCK).

18. The method according to claim 17, wherein the adjusting the phase of the clock signal (CLOCK) comprises setting a predetermined number of starting points in one period of the clock signal (CLOCK), and adjusting the phase of the clock signal (CLOCK) by designating one of the starting points as a starting point of the clock signal (CLOCK).

19. The method according to claim 13, wherein the inserting the reference data (RD) comprises inserting the reference data (RD) into a first line after a horizontal sync signal (H-Sync) in the blank areas based on the sync signal.

20. The method according to claim 19, wherein the digital video data (DATA) comprises digital brightness data (Y-data) and digital color difference data, and the reference data (RD) is inserted into at least one of the digital brightness data (Y-data) and the digital color difference data.

21. The method according to claim 20, wherein the changing the phase of the clock signal (CLOCK) comprises adjusting the phase of the clock signal (CLOCK) such that the amount of phase adjustment is less than one period of the clock signal (CLOCK).

22. The method according to claim 21, wherein the adjusting the phase of the clock signal (CLOCK) comprises setting a predetermined number of starting points in one period of the clock signal (CLOCK), and adjusting the phase of the clock signal (CLOCK) by designating one of the starting points as a starting point of the clock signal (CLOCK).
